(19) United States
(12) Patent Application Publication
(10) Pub. No.: US 2026/0233675 A1
(43) Pub. Date: Aug. 13, 2026

(54) VIRTUAL OUTSIDE REAR VIEW MIRROR

(71) Applicant: GM Global Technology Operations LLC, Detroit, MI (US)

(72) Inventors: Tzvi Philipp, Bet Shemesh (IL); Yael Shmueli Friedland, Tel Aviv (IL); Charles R. Quinn, Pleasant Ridge, MI (US)

(21) Appl. No.: 19/052,476

(22) Filed: Feb. 13, 2025

(51) Int. Cl. B60R 1/26; B60K 35/23; B60K 35/81; B60R 1/25

(52) U.S. Cl. CPC B60R 1/26; B60K 35/23; B60K 35/81; B60R 1/25

(57) ABSTRACT

A rear view imaging system for a vehicle includes a left side camera located at a left side of the vehicle, where the left side camera is oriented to view an area behind the vehicle that is by an occupant in a driver's seat of the vehicle when the occupant looks at an apparent location of a left outside rear-view mirror of the vehicle, a display device for displaying a left rear image at a first display region of a front left side window of the vehicle, wherein a line-of-sight between the occupant and the apparent location of the left outside rear-view mirror passes through the first display region, and a controller to control operation of the display device to display the left rear image in the first display region.

The subject disclosure relates to vehicles, and in particular to a rear view system that displays an image of a rear view scene at a location where it would be seen by a driver of a vehicle otherwise viewing the image in an outside rear-view mirror.

Vehicles include outside rear-view mirrors to reflect images of areas behind the vehicle to the driver, thereby preventing or reducing blind spots. Outside rear-view mirrors tend to project out sideways from the side surfaces of the vehicle. The side surfaces are generally designed with aerodynamic considerations so that air can flow over the surface with reduced drag. The presence of the outside rear-view mirrors interferes with this airflow. Accordingly, it is desirable to replace the outside rear-view mirrors with an imaging system that provides the same imaging capabilities without interrupting air flow over the surface.

### SUMMARY

In one exemplary embodiment, a method of operating a vehicle is disclosed. A left rear image is obtained at a left side camera located at a left side of the vehicle, where the left rear image is of an area viewed by an occupant in a driver's seat of the vehicle when the occupant looks at an apparent location of a left outside rear-view mirror of the vehicle. The left rear image is displayed at a first display region of a front left side window of the vehicle, wherein a line-of-sight between the occupant and the apparent location of the left outside rear-view mirror passes through the first display region.

In addition to one or more of the features described herein, the method further includes displaying the left rear image from a display screen disposed at the front left side window within the first display region.

In addition to one or more of the features described herein, the method further includes projecting the left rear image at the front left side window to appear to the occupant within the first display region using a left side projector.

In addition to one or more of the features described herein, the method further includes at least one of polarizing light transmitted from the left side projector and projecting the left rear image from the left side projector onto the front left side window at an incident angle between 30 degrees and 40 degrees.

In addition to one or more of the features described herein, the method further includes moving the first display region at the front left side window.

In addition to one or more of the features described herein, the method further includes displaying the left rear image at a rear-view mirror of the vehicle when image cannot be viewed at the front left side window.

In addition to one or more of the features described herein, the method further includes obtaining a right rear image at a right side camera located at a right side of the vehicle, and displaying the right rear image at a second display region of a front right side window of the vehicle.

In another exemplary embodiment, a rear view imaging system for a vehicle is disclosed. The rear view imaging system includes a left side camera located at a left side of the vehicle, where the left side camera is oriented to view an area behind the vehicle that is by an occupant in a driver's seat of the vehicle when the occupant looks at an apparent location of a left outside rear-view mirror of the vehicle, a display device for displaying a left rear image at a first display region of a front left side window of the vehicle, wherein a line-of-sight between the occupant and the apparent location of the left outside rear-view mirror passes through the first display region, and a controller to control operation of the display device to display the left rear image in the first display region.

In addition to one or more of the features described herein, the display device further includes a display screen disposed at the front left side window within the first display region.

In addition to one or more of the features described herein, the display device further includes a left side projector configured to project the left rear image at the front left side window to appear to the occupant within the first display region.

In addition to one or more of the features described herein the left side projector is further configured to perform at least one of transmitting polarized light; and projecting the left rear image from the left side projector onto the front left side window at an incident angle between 30 degrees and 40 degrees.

In addition to one or more of the features described herein, wherein the controller is further configured to move the first display region at the front left side window.

In addition to one or more of the features described herein, the rear view imaging system further includes a rear-view mirror including a left mirror display screen for displaying the left rear image.

In addition to one or more of the features described herein, the rear view imaging system further includes a right side camera located at a right side of the vehicle for obtaining a right rear image, and a second display device for displaying the right rear image at a second display region of a front right side window of the vehicle.

In another exemplary embodiment, a vehicle is disclosed. The vehicle includes a left side camera located at a left side of the vehicle, where the left side camera is oriented to view a left side viewing area behind the vehicle that is by an occupant in a driver's seat of the vehicle when the occupant looks at an apparent location of a left outside rear-view mirror of the vehicle, a first display device for displaying a left rear image at a first display region of a front left side window of the vehicle, wherein a line-of-sight between the occupant and the apparent location of the left outside rear-view mirror passes through the first display region, a right side camera located at a right side of the vehicle, where the right side camera is oriented to view a right side viewing area behind the vehicle that is by the occupant looking at the apparent location of a right outside rear-view mirror of the vehicle, a second display device for displaying a right rear image at a second display region of a front right side window of the vehicle, and a controller to control operation of the first display device to display the left rear image in the first display region and the second display device to display the right rear image in the second display region.

In addition to one or more of the features described herein, wherein the first display device further includes a first display screen disposed at the front left side window within the first display region and the second display device further includes a second display screen disposed at the front right side window within the second display region.

In addition to one or more of the features described herein, wherein the first display device further includes a left side projector configured to project the left rear image at the front left side window to appear to the occupant within the first display region and the second display device further includes a right side projector configured to project the right rear image at the front right side window to appear to the occupant within the second display region.

In addition to one or more of the features described herein, wherein at least one of the left side projector and the right side projector is further configured to perform at least one of transmitting polarized light, projecting the left rear image from the left side projector onto the front left side window at an incident angle between 30 degrees and 40 degrees, and projecting the right rear image from the right side projector onto the front right side window at an incident angle between 30 degrees and 40 degrees.

In addition to one or more of the features described herein, wherein the controller is further configured to move one of the first display region at the front left side window and the second display region at the front right side window.

In addition to one or more of the features described herein, the vehicle further includes a rear-view mirror including a left mirror display screen for displaying the left rear image and a right mirror display screen for displaying the right rear image.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows a vehicle in a side view, in accordance with an exemplary embodiment;

FIG. 2 shows a partial perspective view of the vehicle;

FIG. 3 shows a schematic top view illustrating a rear view imaging system of the vehicle, in an embodiment;

FIG. 4 shows a schematic top view illustrating a rear view imaging system of the vehicle, in another embodiment; and

FIG. 5 shows an interior rear-view mirror of the vehicle in an illustrative embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

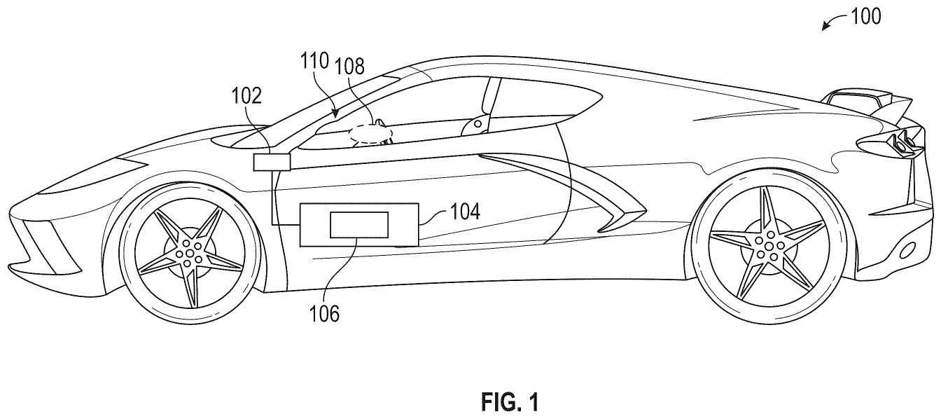

In accordance with an exemplary embodiment, FIG. 1 shows a vehicle 100 in a side view. The vehicle 100 can be any type of vehicle. The vehicle 100 includes a camera 102 and a display device (not shown). In general, the vehicle does not include an outside rear-view mirror, which is typically located on the front side door on either the left side or right side. The camera 102 can be located at a side of the vehicle and takes an image of a region that would otherwise be seen by the driver through the outside rear-view mirror from the driver's seat. The camera 102 can be located within a side panel of the vehicle to produce little or no perturbation in the flow of air along the side panel.

The camera 102 can be a digital camera that obtains a digital image or a digital video recorder that captures a plurality of temporally spaced digital images.

The vehicle 100 includes a controller 104 having a processor 106. The controller 104 may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. The controller 104 may also include a non-transitory computer-readable medium that stores instructions which are processed by one or more processors of the controller to implement processes detailed herein.

The camera 102 provides an image to the controller 104. The controller 104 can select a display device (not shown in FIG. 1) and display the image captured by the camera 102 at a first display region 108. The first display region 108 is located at a front left side window of the vehicle along a line-of-sight between the eyes of the driver and a location of the outside rear view mirror (not shown in FIG. 1). Since the vehicle 100 disclosed herein does not include an outside rear view mirror, the location that the outside rear view mirror would be is referred to herein as an apparent location. The apparent location can be located at or near an A-pillar 110 of the vehicle 100. As shown the display device displays an image at a front left side window of the vehicle. A second display device can be used to display another image at another location, such as at a right side window of the vehicle, as discussed herein.

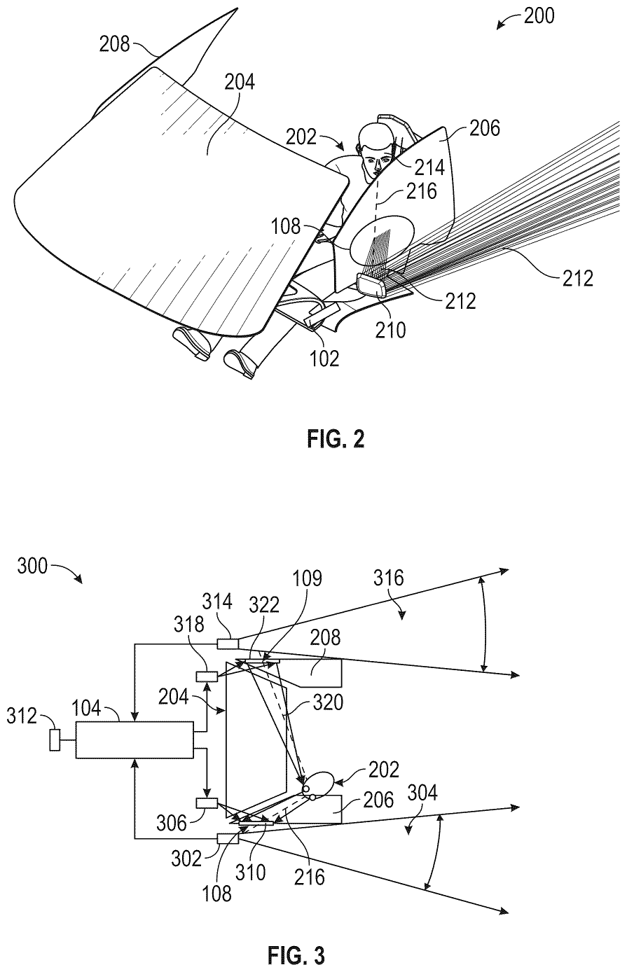

FIG. 2 shows a partial perspective view 200 of the vehicle 100. The perspective view 200 is obtained from a top driver's side location and shows the driver and various windows of the vehicle. Many features of the vehicle 100 are removed for ease of explanation. The perspective view 200 includes the driver 202, a front windshield 204, a front left side window 206, and a front right side window 208. An outside rear-view mirror 210 is shown for purposes of explanation, even though the vehicle does not include the outside rear-view mirror. The driver 202 views an image in the outside rear-view mirror 210 of an area outlined by rays 212. The rays 212 along a line-of-sight 216 between the eyes 214 of the driver 202 and the outside rear-view mirror 210 pass through the front left side window 206 to define the first display region 108. A camera 102 is shown that captures the rays 212 emanating from behind the vehicle that would otherwise be captured by the outside rear-view mirror.

The camera can be recessed into a cavity below the surface of the vehicle or be within a small protrusion at the surface.

FIG. 3 shows a schematic top view 300 illustrating a rear view imaging system of the vehicle 100, in an embodiment. The top view 300 includes the front windshield 204, the front left side window 206 and the front right side window 208. A left side camera 302 is located at the left side of the vehicle 100 and is oriented to obtain a left rear image over a left side viewing area 304 of the vehicle. In various embodiments, the left side viewing area 304 is the same or similar to the viewing area outlined by rays 212 in FIG. 2. The left side camera 302 sends the left rear image to the controller 104. The controller 104 can determine a configuration of the vehicle 100 and display the left rear image in an appropriate location based on the configuration. As shown in FIG. 3, the configuration of the vehicle has the front left side window 206 in a raised position (e.g., an “up” position). Thus, the controller 104 selects to display the left rear image at a first display region 108 at the front left side window 206. In FIG. 3, the controller 104 is in communication with a left side projector 306. The left side projector 306 projects the left rear image onto the first display region 108 of the front left side window 206.

The left rear image is projected to reflect off the first display region 108 at an angle such that the reflected light is along the left-side line-of side (i.e., line-of-sight 216) between the outside rear-view mirror and the eyes of the driver. In an embodiment, the left side projector 306 projects the left rear image onto the front left side window 206 at an angle between about 30 degrees to about 40 degrees from the plane of the window (i.e., an incident angle between about 60 degrees and 50 degrees). The first display region 108 can include a first film 310 upon which the left rear image can be projected. The first film 310 reflects light and prevents or reduces transmission of light through the front left side window, thereby maximizing reflected light. Also, the light from the left side projector 306 can be polarized to maximize reflected light. In addition, the controller 104 can control the left side projector 306 to increase or decrease the intensity of light for the left rear image based on an ambient light. A sensor 312 can be used to detect ambient light.

Similarly, the vehicle 100 includes a right side camera 314 located at the right side of the vehicle and oriented to obtain a right rear image over a right rear-view area 316 of the vehicle. The right side camera 314 sends the right rear image to the controller 104 which checks the configuration of the front right side window 208. The controller 104 displays the right rear image at the front right side window 208 when this window is in a raised position. The controller 104 is coupled to a right side projector 318 which projects the right rear image onto the front right side window 208 in the manner discussed herein with respect to the left projector. The right rear image is seen along a right-side line-of-sight 320 for the driver 202. A second film 322 can be placed in the front right side window 208 for the same purposes as discussed herein with respect to the first film 310.

The driver 202 or occupant can communicate with the controller 104 to adjust the angle of the left side projector 306 to move the first display region 108 at the front left side window 206 to a desired location. Similarly, the driver 202 can adjust the angle of the right side projector 318 to move a second display region 109 at the front right side window 208 to a desired location.

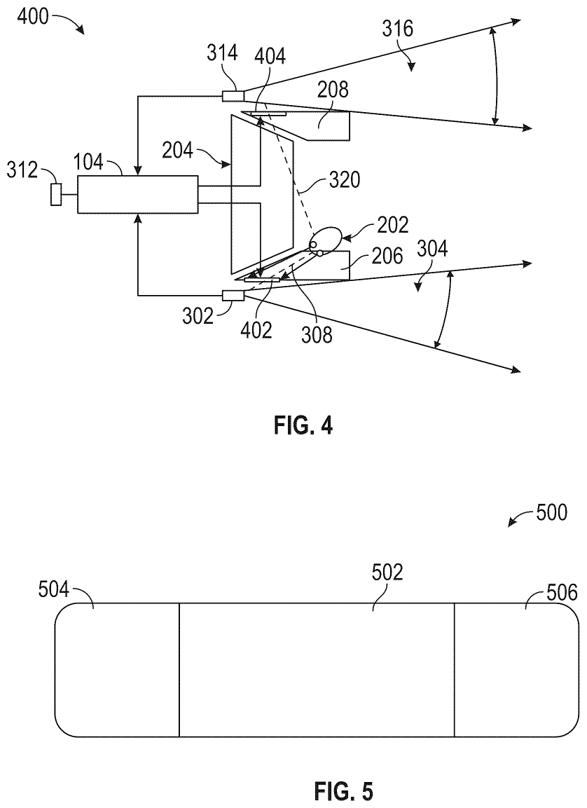

FIG. 4 shows a schematic top view 400 illustrating a rear view imaging system of the vehicle, in another embodiment. The top view 400 includes the front windshield 204, the front left side window 206 and the front right side window 208. The left side camera 302 is located at the left side of the vehicle 100 and is oriented to obtain a left rear image over a left side viewing area 304 of the vehicle. The left side camera 302 sends the left rear image to the controller 104. The controller 104 is in communication with a left window display screen 402 located in the front left side window 206 and sends the left rear image to the display screen. The left window display screen 402 can be a thin film display such as a micro-LED display. The left window display screen 402 can be sandwiched between panes of the front left side window 206. In addition, the controller 104 can control the left window display screen 402 to increase or decrease the intensity of light for the left rear image based on an ambient light. Electrical power and signals can be distributed to the micro-LED display in the glass of the side window by means of a ribbon cable type or wire harness.

Similarly, the vehicle 100 includes a right side camera 314 located at the right side of the vehicle and oriented to obtain a right rear image over a right rear-view area 316 of the vehicle. The right side camera 314 sends the right rear image to the controller 104 which sends the right rear image to a right window display screen 404. The right window display screen 404 displays the right rear image at the front right side window 208 in the manner discussed herein with respect to the right window display screen 404.

The images can be shown at their respective display screens, with each display screen using a subset of the pixels of the display screen. The driver 202 or occupant can communicate with the controller 104 to adjust the location of the display region at the display screen. The display screen moves the location of the display region by changing its selection of pixels (or the subset of pixels) for displaying the image.

FIG. 5 shows an interior rear-view mirror 500 of the vehicle 100 in an illustrative embodiment. The rear-view mirror 500 has a standard viewing area 502 through which the driver 202 is able to see behind the vehicle through the rear windshield. A left mirror display screen 504 is on a left side of the standard viewing area 502 and a right mirror display screen 506 is on a right side of the standard viewing area 502. The controller 104 can send a left rear image that otherwise is shown at the front left side window 206 to the left mirror display screen 504 when it has determined that conditions are unsuitable for showing the left rear image at the front left side window 206. Conditions are unsuitable when the front left side window 206 has been rolled down to an extent that the left rear image from the left side projector is no longer incident on the left side window. Conditions are also unsuitable when the front left side window 206 has been rolled down to an extent that the left window display screen 402 is no longer visible to the driver 202. Similarly, the controller 104 can send the right rear image that otherwise is shown at the front right side window 208 to the right mirror display screen 506 when conditions are unsuitable for displaying the right rear image at the front right side window.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

1. A method of operating a vehicle, comprising:
obtaining a left rear image at a left side camera located at a left side of the vehicle, where the left rear image is of an area viewed by an occupant in a driver's seat of the vehicle when the occupant looks at an apparent location of a left outside rear-view mirror of the vehicle;
displaying the left rear image at a first display region of a front left side window of the vehicle, wherein a line-of-sight between the occupant and the apparent location of the left outside rear-view mirror passes through the first display region; and
displaying the left rear image at a rear-view mirror of the vehicle when the front left side window has been rolled down such that the first display region is no longer visible to the driver.

2. The method of claim 1, further comprising displaying the left rear image from a display screen disposed at the front left side window within the first display region.

3. The method of claim 1, further comprising projecting the left rear image at the front left side window to appear to the occupant within the first display region using a left side projector.

4. The method of claim 3, further comprising at least one of: (i) polarizing light transmitted from the left side projector; and (ii) projecting the left rear image from the left side projector onto the front left side window at an incident angle between 30 degrees and 40 degrees.

5. The method of claim 1, further comprising moving the first display region at the front left side window.

6. (canceled)

7. The method of claim 1, further comprising obtaining a right rear image at a right side camera located at a right side of the vehicle, and displaying the right rear image at a second display region of a front right side window of the vehicle.

8. A rear view imaging system for a vehicle, comprising:
a left side camera located at a left side of the vehicle, where the left side camera is oriented to view an area behind the vehicle that is by an occupant in a driver's seat of the vehicle when the occupant looks at an apparent location of a left outside rear-view mirror of the vehicle;
a display device for displaying a left rear image at a first display region of a front left side window of the vehicle, wherein a line-of-sight between the occupant and the apparent location of the left outside rear-view mirror passes through the first display region;
a rear-view mirror; and
a controller to control operation of the display device to display the left rear image in the first display region, wherein the controller is configured to display the left rear image at the rear view mirror when the front left side window has been rolled down such that the first display region is no longer visible to the driver.

9. The rear view imaging system of claim 8, wherein the display device further comprises a display screen disposed at the front left side window within the first display region.

10. The rear view imaging system of claim 8, wherein the display device further comprises a left side projector configured to project the left rear image at the front left side window to appear to the occupant within the first display region.

11. The rear view imaging system of claim 10, wherein the left side projector is further configured to perform at least one of: (i) transmitting polarized light;
and (ii) projecting the left rear image from the left side projector onto the front left side window at an incident angle between 30 degrees and 40 degrees.

12. The rear view imaging system of claim 8, wherein the controller is further configured to move the first display region at the front left side window.

13. (canceled)

14. The rear view imaging system of claim 8, further comprising a right side camera located at a right side of the vehicle for obtaining a right rear image, and a second display device for displaying the right rear image at a second display region of a front right side window of the vehicle.

15. A vehicle, comprising:
a left side camera located at a left side of the vehicle, where the left side camera is oriented to view a left side viewing area behind the vehicle that is by an occupant in a driver's seat of the vehicle when the occupant looks at an apparent location of a left outside rear-view mirror of the vehicle;
a first display device for displaying a left rear image at a first display region of a front left side window of the vehicle, wherein a line-of-sight between the occupant and the apparent location of the left outside rear-view mirror passes through the first display region;
a right side camera located at a right side of the vehicle, where the right side camera is oriented to view a right side viewing area behind the vehicle that is by the occupant looking at the apparent location of a right outside rear-view mirror of the vehicle;
a second display device for displaying a right rear image at a second display region of a front right side window of the vehicle;
a rear-view mirror; and
a controller to control operation of the first display device to display the left rear image in the first display region and the second display device to display the right rear image in the second display region, wherein the controller is configured to perform at least one of displaying the left rear image at the rear view mirror when the front left side window has been rolled down such that the first display region is no longer visible to the drive and displaying the right rear image at the rear view mirror when the front right side window has been rolled down such that the second display region is no longer visible to the driver.

16. The vehicle of claim 15, wherein the first display device further comprises a first display screen disposed at the front left side window within the first display region and the second display device further comprises a second display screen disposed at the front right side window within the second display region.

17. The vehicle of claim 15, wherein the first display device further comprises a left side projector configured to project the left rear image at the front left side window to appear to the occupant within the first display region and the second display device further comprises a right side projector configured to project the right rear image at the front right side window to appear to the occupant within the second display region.

18. The vehicle of claim 17, wherein at least one of the left side projector and the right side projector is further configured to perform at least one of: (i) transmitting polarized light; (ii) projecting the left rear image from the left side projector onto the front left side window at an incident angle between 30 degrees and 40 degrees;
and (iii) projecting the right rear image from the right side projector onto the front right side window at an incident angle between 30 degrees and 40 degrees.

19. The vehicle of claim 15, wherein the controller is further configured to move one of; (i) the first display region at the front left side window; and
(ii) the second display region at the front right side window.

20. (canceled)

21. The method of claim 1, further comprising detecting an ambient light and changing an intensity of light at the first display region based on the ambient light.

22. The rear view imaging system of claim 8, wherein the controller is further configured to change an intensity of light at the first display region based on an ambient light.

23. The vehicle of claim 15, wherein the controller is further configured to change an intensity of light at either the first display region or the second display region based on an ambient light.
